(19) United States
(12) Patent Application Publication
(10) Pub. No.: US 2014/0039669 A1
(43) Pub. Date: Feb. 6, 2014

(54) METHOD OF TRANSPORTING AND SORTING AND SYSTEM FOR EXERCISING THE METHOD

(71) Applicants: Uffe Lykkegaard, Århus C (DK); Lasse Lund Jensen, Skødstrup (DK)

(72) Inventors: Uffe Lykkegaard, Århus C (DK); Lasse Lund Jensen, Skødstrup (DK)

(73) Assignee: CRISPLANT A/S, Århus N (DK)

(21) Appl. No.: 14/003,749

(22) PCT Filed: Mar. 14, 2011
(86) PCT No.: PCT/DK11/50083

§ 371 Date: Oct. 10, 2013

(51) Int. Cl. B65G 1/137

(52) U.S. Cl. CPC B65G 1/137
USPC 700/218

(57) ABSTRACT

The invention relates to a method of handling a variety of objects of different size, shape and weight, where each object is to be transported to a specific destination, where the transportation involves transportation on a conveyor system (4) and discharge from the conveyor system (4) to at least one intermediate elongate storage device (5-10), the method comprising the steps of determining desired position of an object on the intermediate elongate storage device (5-10) and discharging the object with one of at least two speed levels in the longitudinal direction of the storage device (5-10) that allows the object to reach the desired position. The invention further relates to a handling system for performing the method as well as a control system for controlling such system.

### FIELD OF TECHNOLOGY

The invention relates to the field of technology adapted to transport and sort objects, such as packages, parcels, luggage and similar discrete objects with a significant variety of size, shape and weight. The sorting and transportation most often is performed automatically on conveyor systems and is based on various types of tagging, e.g. bar code tagging, which allows the conveyor system to direct the individual object to a particular determined discharge location in the conveyor system.

### BACKGROUND OF THE TECHNOLOGY

In a situation where the conveyor system has transported the object to the determined discharge location of the system, the object often is discharged into or onto a further transportation device or storage device. This operation requires a manual interaction as the objects need to be distributed evenly in or on the transportation or storage device. Manually handling the objects involves heavy lifts for the involved personnel and as in particular the weight differ a lot this also involves a significant health risk.

The problem involved in this operation is as such well known and many attempts have been made to overcome the problem, however none of these have been successful and the basic problem still exists.

As an example of the prior attempts of solving the underlying problem can be mentioned the technology disclosed in EP 2057063, where the problem is sought solved through a specially designed cart.

Another example is disclosed in U.S. Pat. No. 7,753,191, where a specially designed transportation device together with a dedicated loading system is foreseen for solving the problem.

Still further a solution is disclosed in DE 102009039034, where a system comprising an adjustable chute and a tiltable container is defined for solving the problem.

Common for these prior known solutions is that they require a relatively high amount of specialized equipment that will involve significant investments and/or a significant amount of maintenance and/or a decreased availability, which for obvious reasons is not desired.

The objective of the present invention is to provide a solution to the problem related to manual operation, and which further overcomes the shortcomings of the previously known technology.

### SUMMARY OF THE INVENTION

According to the invention this is achieved by means of a method of handling a variety of objects of different size, shape and weight, where each object is to be transported to a specific destination, where the transportation involves transportation on a conveyor system and discharge from the conveyor system to at least one intermediate elongate storage device, the method comprising the steps of determining desired position of an object on the intermediate elongate storage device and discharging the object with one of at least two speed levels in the longitudinal direction of the storage device that allows the object to reach the desired position.

By using the defined method it is possible to use existing storage devices, such as baggage trolleys in airports, for the onward transportation and thereby reducing the necessary investment. The manual operations are significantly reduced and often eliminated as the objects leaving the conveyor system will reach a position in the storage device according to or at least approximately according to the desired position. The distribution criteria in various storage devices may include destination and further also a graduation of the baggage for same destination, for example having flight classes separated into separate storage devices, e.g. when the system and method is used in a an airport.

When considering the type of storage device as being elongate this may be in respect of both width and length, as the method relates to the distance in discharge from the discharge device to the desired position in or on the storage device.

In a preferred embodiment a number of objects are transported on a plurality of conveyor means from a first area to a second area, at which second area the objects are discharged on or in a storage device, such as an airport wagon, the method further comprising steps of
discharging the objects on or in the storage device by a displacement device, e.g. a driven conveyor or a pushing device, and
discharging one or more initial objects on or in the storage device with a first speed, e.g. a first driving speed of the driven conveyor,
discharging one or more following objects on or in the storage device with a second speed, e.g. a second speed of the driven conveyor, where the first speed is slower than the second speed.

Alternatively the first speed is faster than the second speed.

Preferably objects are discharged directly on or in said storage device from a side of said storage device and perpendicular or substantially perpendicular to said side by the driven conveyor and from a first vertical level relative to a loading edge of the storage device and further comprising discharging one or more following objects on or in said storage device from a second vertical level which is increased relatively to the first vertical level. At each vertical level the discharge may be carried out at different discharge speeds according to the desired position of the discharge object.

Preferably the first vertical level is equal to or substantially equal to, such as just slightly above a vertical level of an upper edge of the storage device and the second vertical level is about 0.05-0.40 meter above an upper edge of the storage device.

Preferably an end of the driven conveyor from which the objects are discharged is aligned with or substantially aligned with and adjoining or substantially adjoining the side of said storage device. This will make the discharge process much more predictable.

In some cases the method may further comprise methods steps of manually spreading objects already present in the storage device one or more times prior to having a filled storage device and preferably while momentarily stopping discharging objects into the storage device prior to manually spreading the objects.

In an embodiment the method comprises selection of one or more certain types of objects for being discharged on or in the storage device, at a certain moment during filling of the storage device. This may include discharging a soft object, e.g. a soft baggage piece, as the initial object onto or into a yet unfilled storage device. In particular this may comprise selecting one or more objects for discharging at a given moment on or in a particular storage device among a plurality of storage devices.

The method may comprise discharging an object on or into a left or a right storage device, such as 5 and 8, respectively, as shown in the figures, from and with the discharge means 4. This can be provided by reversing the driving direction of the driven conveyor belt and in particular discharging on or into a particular storage device from the side of the storage devices, by transferring the driven conveyor in a direction corresponding to a direction of the side of one or more storage devices.

The method preferably comprises that the storage device, when filled to a certain level, is moved from the second area to e.g. an aeroplane at which aeroplane the objects collected in the storage device is loaded into the aeroplane from the storage device. At the aeroplane a ramp connector device may preferably be provided for unloading the objects, in this case baggage pieces, hereby reducing the manual labour force required. At arrival when the trolleys are loaded at the aeroplane and further when unloading the trolleys at the airport baggage handling a similar ramp connector device may advantageously be used.

Advantageously the method comprises that the filling of a storage device is determined and upon reaching a certain predetermined level stopping the filling of the present storage device and if necessary starting filling of a further storage device.

Further according to the invention the objective is achieved through an object handling system, where the system adapted to transport objects of varying size, shape and weight from a first area to a second area, and where the system comprises discharge means adapted to discharge the objects at least at two different levels of speed into at least one elongate intermediate storage device.

Advantageously the system comprises a control system adapted to direct the object to an intended discharge location and determining the speed level for the intended discharge location.

The control system preferably operates according to a predetermined scheme or algorithm and according to the intended destination and the present filling state of the relevant storage device and thus the control system determines the relevant discharge speed for the object.

The discharge means e.g. comprises a driven conveyor or a pusher, and further control means capable of controlling the discharge speed of the object by controlling the speed of the driven conveyor or the pusher.

In an embodiment the system comprises a plurality of conveyor means adapted to transport objects from a first area to a second area, at which second area said objects are loaded on or in a storage device, such as an airport wagon, said system further comprising:
a driven conveyor adapted to discharge objects into said storage device to collect a plurality of objects in the storage device, the driven conveyor being configured to discharge objects directly on or in said storage devices from a side of said storage device and substantially perpendicular to the side by the driven conveyor from a first vertical level relative to a loading edge of the storage device, and
a control system for controlling operation of the system, the control system furthermore being configured to discharge one or more initial objects on or in the storage device with a driving speed of the driven conveyor which is less than the driving speed of the driven conveyor upon discharging one or more following objects which follows the initially discharged objects.

Furthermore the control system is configured to discharge one or more of said following objects on or in said storage device from a second vertical level which is increased relatively to the first vertical level.

In an embodiment a plurality of storage devices, such as 2-8 storage devices, are positioned in the second area and the driven conveyor is provided in a transfer system, which transfer system is configured to transfer the driven conveyor with one or more objects on the conveyor, to a position so as to enable discharge of the one or more objects on or into one of said storage devices from a side of said storage device.

The transfer system and control system is adapted so as to transfer a plurality of objects on one or more driven conveyors comprised in the transfer system at once and so as to discharge selected objects transferred on the one or more driven conveyors to one or more selected storage devices.

The system may further comprise means for detecting the filling of a storage device, where the detection means e.g. comprise one or more of the following: a counter, a photoelectric sensor and/or a vision device such as a camera with relevant pattern recognition software.

According to the invention the objective of the invention is achieved through a control system for use in an object handling system according to any of the preceding claims, where the control system comprises memory means for storing information on a certain destination for an intermediate storage device, memory means for storing information on the last discharged object and means for determining the discharge speed for the next following object into the storage device. The stored information relevant may be the position or the discharge speed of the last object discharged, and which is used to determine the speed level for the next object to be discharged.

Through such control system it is possible to provide the functionality of the present invention to existing systems and hence reduce the manual labour activity significantly.

Preferably the control system further comprises memory means for storing information on the present filling of an intermediate storage device and means for allocating a next storage device upon reaching a predetermined level of filling, e.g. a certain number of objects or reaching a certain height or vertical level of a pile of objects, in the present storage device. Combinations of such devices are possible solutions for optimizing the filling control.

In accordance with possible embodiments of the invention an elongated intermediate storage device, such as an airport wagon, has a width side or end which is narrow compared to a length of the storage device as illustrated herein. A transfer means adapted for transferring discharge means may also be positioned, arranged and adapted as illustrated in an area above couplings of pairs of storage devices. Further a first dimension of the discharge means, i.e. a first dimension of a carrying surface of the discharge means, is equal to or substantially equal to the width of the storage device. Still further it is disclosed herein that a second dimension of the discharge means, perpendicular to said first dimension, is equal to or substantially equal to a distance between coupled pairs of storage devices. One or more of these dimensions and/or widths, lengths and positions among other enables discharge of objects to a left and/or right side storage device from the discharge means.

In case a certain location in the width direction of a storage device is to be obtained, the discharge means may be positioned in the transfer means or here moreover carrier beam, at a given position such as slightly towards one or the other length sides of the storage device instead of in the middle or substantially in the middle of the storage device as possibly preferred. Alternatively or additionally, an object may be positioned towards one or the other extremity along the 1. dimension of the discharge means, in order to be able to obtain a certain end location of such object in a storage device. Even, if not intentionally positioned and/or rotated in a certain way on the discharge means, a certain obtained position and/or rotation of an object on the discharge means, which may be detected or obtained by means known in the art, and/or size and/or shape and/or weight of the object may be correlated to a certain free or optimum position of such object in a certain storage device and the object can be chosen to be discharged at such location, possibly using other aspects disclosed herein.

The invention will in the following be described in more detail with reference to a preferred embodiment depicted in the drawings.

### DESCRIPTION OF THE DRAWINGS

FIG. 1 is a perspective view of a system according to the invention;

FIG. 2 is a top view of a system according to the invention;

FIG. 3 is a side view of a system according to the invention;

FIG. 4 is a schematic drawing showing the discharge of objects at different speeds and

FIG. 5 illustrates an embodiment of the method and system in which difference in speed of the objects is used to form a wedge formed pile of objects.

### DESCRIPTION OF PREFERRED EMBODIMENTS

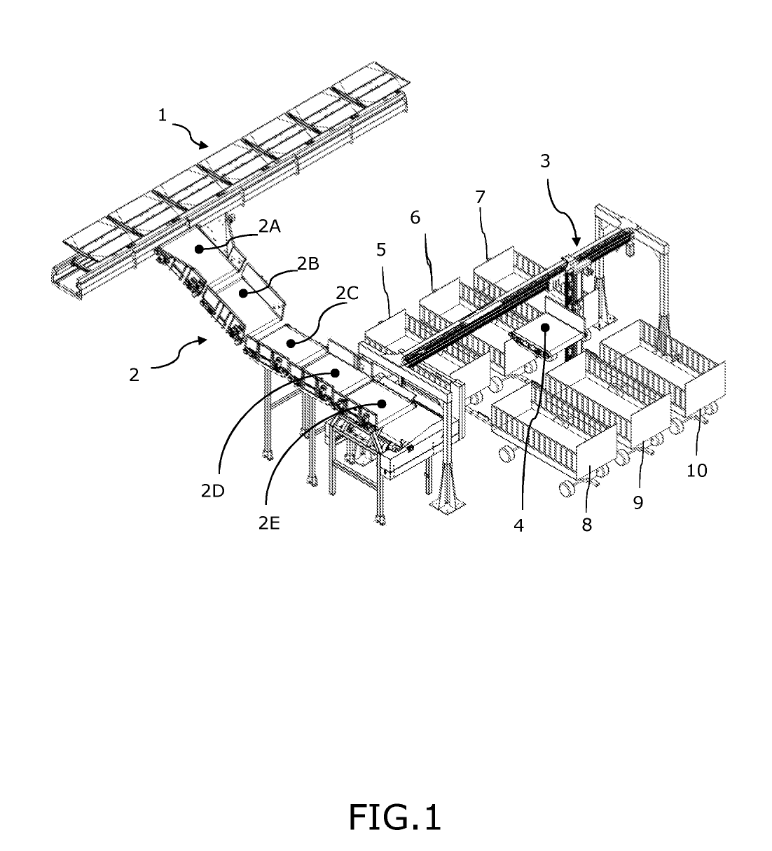

From FIG. 1 an embodiment of the system according to the invention appears in a perspective view. A part of the main sorting system is shown as 1. The carts on the main system are tiltable and capable of delivering their load onto a discharge system 2,3,4, where the first part 2 comprises of a number of driven conveyors 2A-2E and where the final discharge unit 3,4 comprises horizontal carrier beam 3 capable of carrying the discharge conveyor system including the discharge conveyor 4 as well as means for horizontally and vertically displacing this on the vertical carrier beam. The discharge conveyor is a driven belt conveyor, where the drive speed of this can be controlled by a control unit (not shown). On both sides of the horizontal carrier intermediate storage devices in the form of airport wagons or trolleys 5-10 are shown. The trolleys are connected in sets of two, and the discharge conveyor is movable horizontally over the interconnection area of the trolleys. By having this position in relation to the trolleys the discharge may be performed to either of the two sides by simply reversing the rotation of the belt of the discharge conveyor. The discharge conveyor will deliver the object, e.g. a baggage piece to the correct trolley according to the tagging of the object. Furthermore the discharge conveyor will be controllable to deliver the object with a speed capable of reaching a desired area of the trolley, where clearly reaching the far most away end of the trolley will require an increased discharge speed than the same for the nearest end. Furthermore the delivery position on the trolley may be influenced by the vertical level of the discharge conveyor, where for the same discharge speed an increased vertical level position of the discharge conveyor will make the object reach a position closer to the far most away end of the trolley, when seen from a discharge means 3 as positioned herein.

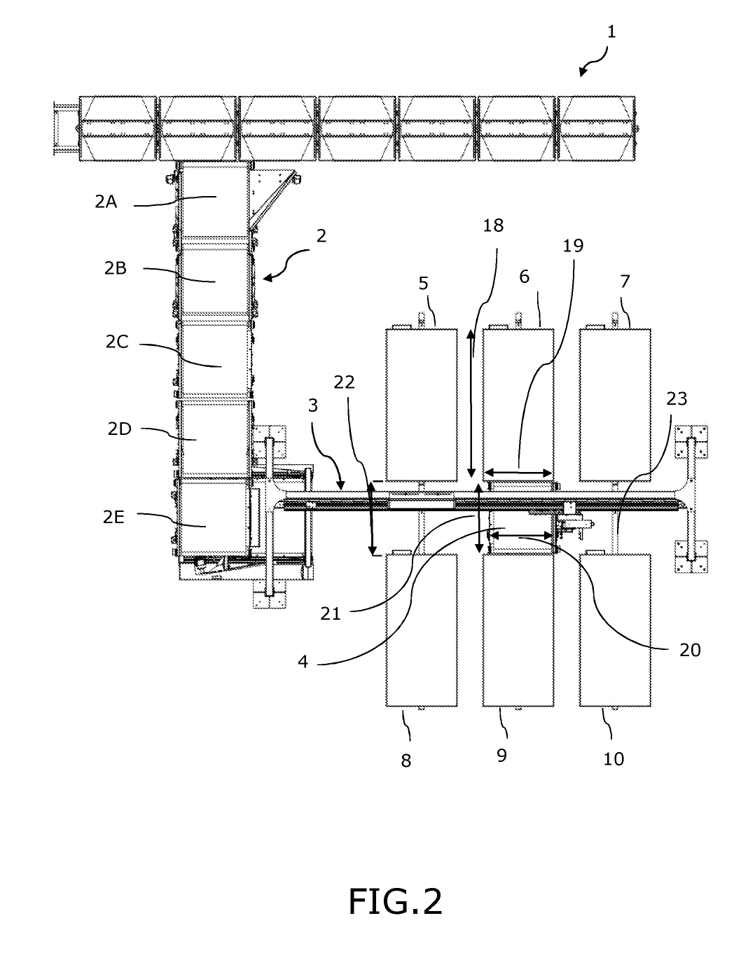

From FIG. 2 the same system appears in a top view. It appears that the discharge conveyor 4, which in this case is facing two of the intermediate storage devices or trolleys 6,9, will be capable of discharging its load to either side depending on the direction of the rotation of the belt carrying the object.

Furthermore it follows from FIG. 2 that in the example the elongated intermediate storage devices 5-10, such as the wagon 6, have a width side or end 19 which is narrow compared to a length 18 of the storage device or in this case airport wagon 6. It also follows that the transfer means adapted for transferring the discharge means, in the shown example the carrier beam 3, is positioned, arranged and adapted as illustrated in an area above couplings 23 of pairs of storage devices. It further follows that a first dimension 20 of the discharge means, i.e. a first dimension of a carrying surface of the discharge means 4, is equal to or substantially equal to the width 19 of the storage device 6. Still further it follows and is illustrated that a second dimension 21 of the discharge means 4, perpendicular to said first dimension, is equal to or substantially equal to a distance between coupled pairs of storage devices, such as the 6 and 9. One or more of these dimensions and/or widths, lengths and positions among other enables discharge of objects to a left and/or right side storage device from the discharge means 4.

In case a certain location in the width direction of a storage device is to be obtained, the discharge means 4 may be positioned in the transfer means 3 or here moreover carrier beam, at a given position such as slightly towards one or the other length sides of the storage device instead of in the middle or substantially in the middle of the storage device as possibly preferred. Alternatively or additionally, an object may be positioned towards one or the other extremity along the 1. dimension of the discharge means 4, in order to be able to obtain a certain end location of such object in a storage device. Even, if not intentionally positioned and/or rotated in a certain way on the discharge means 4, a certain obtained position and/or rotation of an object on the discharge means 4, which may be detected or obtained by means known in the art, and/or size and/or shape and/or weight of the object may be correlated to a certain free or optimum position of such object in a certain storage device and the object can be chosen to be discharged at such location, possibly using other aspects disclosed herein.

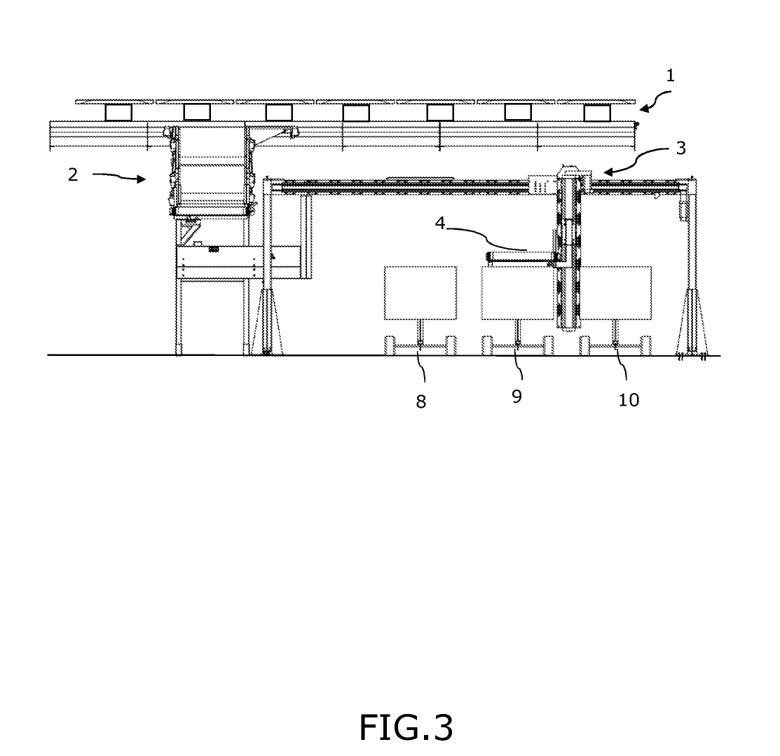

From FIG. 3 still the same system appears in a side view, where the vertical level adjustment of the discharge conveyor 4 appears more clearly.

The equipment shown in FIG. 1-3 are provided for executing a method of handling a variety of objects of different size, shape and weight, where each object is to be transported to a specific destination. The transportation involves transportation on a conveyor system and discharge from the conveyor system to an intermediate elongate storage device and the method comprises the steps of determining desired position of the object on the intermediate elongate storage device and discharging the object with a speed in the longitudinal direction that allows the object to reach the desired position.

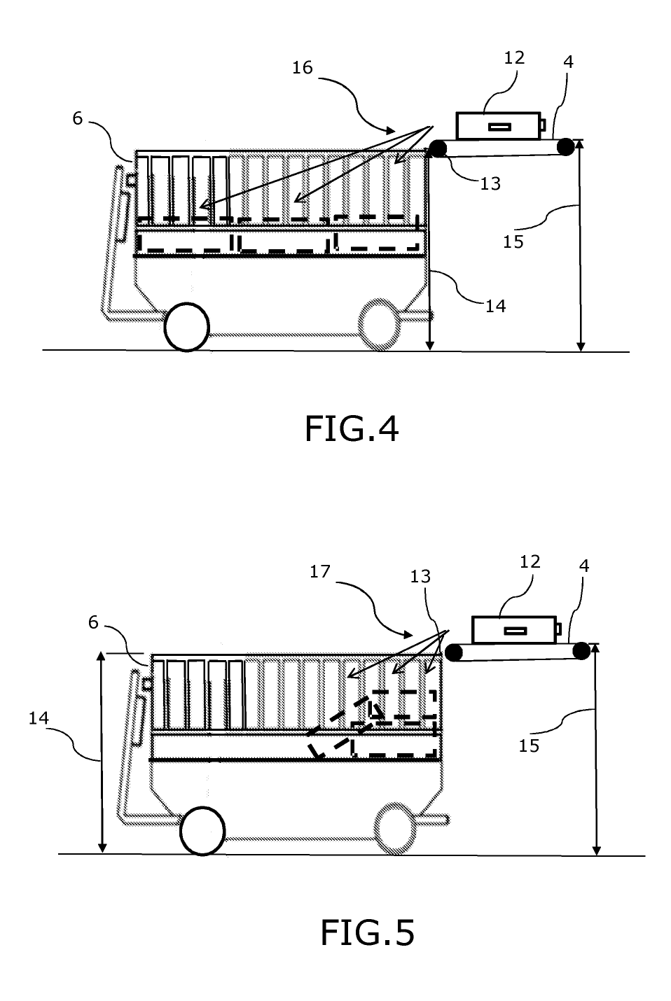

FIG. 4 depicts in a schematic manner the functionality of the present method and system. The driven conveyor 4 will due to its driving speed discharge an object 12, such as a baggage piece or a parcel, with a speed corresponding to the driving speed of the conveyor. By varying the driving speed the distance reached by the object may be controlled. In FIG. 4 three different end locations in an intermediate storage device 6 of an object are shown with dotted line objects. The arrows 16 pointing at the three locations indicate three different speed levels of discharge. Thus in FIG. 4 different speed of the objects are used in order to provide different end locations and in the shown example so as to build a layer of objects in the intermediate storage device, which layer, as illustrated substantially fill the bottom of the storage device.

The vertical level 15 of an upper surface of the discharge means 4, on which surface the objects to be discharged rest until being discharged by applying a force to the object with the discharge means, is shown to be just slightly above the vertical level 14 of an upper edge, which in the shown example equals a loading edge 13 of the intermediate storage device 6.

The control of the discharge requires that the destination of the storage device is known and that the present filling state of the storage device is known. Having this information available the required discharge speed of the following object to be placed in a storage device may be determined by either a predetermined scheme of speeds corresponding to certain locations in the storage device or an algorithm for calculating the relevant speed for the object in question. The storage device obviously will have a limit of available space, and keeping track of the filling will include stopping the filling when reaching a certain level. The stopping of the filling may in a simple fashion be determined by having a limit to the number of objects to be placed in the storage device, such as for example 15 objects, which may be a likely number for filling a trolley in an airport baggage transportation system. Other means for controlling the filling may include photo sensors that are place on fixed locations around the filling area or on the discharge unit and which register a vertical filling level which stacked objects in the intermediate storage has reached. Finally vision systems with cameras and appropriate pattern recognition software may be used for the control of the filling.

In operation the discharge conveyor may be controlled to discharge an object close to the conveyor as the first and successively discharge the following objects using an increased discharge speed for each of these in order to reach a further distance from the initially discharged object. Elevating the discharge conveyor to a higher vertical level or position may be used in order to change the discharge position and the discharge may follow a similar pattern as with a lower position using an increased speed for successive discharges. Performing the discharge with a reverse order of speed change, i.e. starting out with the highest speed and lowering the speed for successive discharges may be an alternative strategy for control of the filling of the storage device.

While the invention is explained in connection with a conveyor setup and a driven conveyor as the discharge means, this should not be considered a limitation of the invention as alternative means for discharging the objects may be used. Similarly other means for delivering the objects to the discharge means may be provided, e.g. the objects may be discharged directly from a sorter system to the discharge means without an intermediate conveyor system.

FIG. 5 illustrates an embodiment of the method and system in which difference in speed, illustrated in this case with the arrows 17, of the objects is used to form a kind of ‘chute formed pile of objects’ towards the discharge means or in other words to form a substantially wedge shaped pile of objects in the intermediate storage 6 towards the discharge means. Such wedge shaped pile of object may be build in the storage in order to be able to let further objects be discharged along the wedge and sliding on top of the objects previously discharged and towards a far end of the intermediate storage device, when seen from the loading edge 13. Still further a pile may be build in one or both ends of the storage device, possibly on top of a layer as described in FIG. 4.

1. A method of handling a variety of objects of different size, shape and weight, where each object is to be transported to a specific destination, where the transportation involves transportation on a conveyor system and discharge from the conveyor system to at least one intermediate elongate storage device, the method comprising:
determining a specific destination for an object on the at least one intermediate elongate storage device; and
discharging the object with one of at least two speed levels in a longitudinal direction of the at least one intermediate elongate storage device that allows the object to reach the specific destination.

2-25. (canceled)

26. The method according to claim 1, wherein a plurality of objects are transported on a plurality of conveyors from a first area to a second area, at which second area the plurality of objects are discharged on or in a storage device or airport wagon, the method further comprising:
discharging the objects on or in the storage device or airport wagon by a displacement device, a driven conveyor, or a pushing device, and
discharging one or more initial objects on or in the storage device or airport wagon with a first speed, or a first driving speed of the displacement device, the driven conveyor, or the pushing device, and
discharging one or more following objects on or in the storage device or airport wagon with a second speed, or a second driving speed of the displacement device, the driven conveyor, or the pushing device, wherein the first speed or first driving speed is slower than the second speed or second driving speed.

27. The method according to claim 1, wherein a plurality of objects are transported on a plurality of conveyors from a first area to a second area, at which second area the objects are discharged on or in a storage device or an airport wagon, the method further comprising:
discharging the objects on or in the storage device or airport wagon by a displacement device, a driven conveyor, or a pushing device, and
discharging one or more initial objects on or in the storage device or airport wagon with a first speed or a first driving speed of the displacement device, the driven conveyor, or the pushing device,
discharging one or more following objects on or in the storage device or airport wagon with a second speed, or a second driving speed of the displacement device, the driven conveyor, or the pushing device, wherein the first speed or first driving speed is faster than the second speed or second driving speed.

28. A method according to claim 26, wherein objects are discharged directly on or in said storage device or airport wagon from a side of said storage device or airport wagon and perpendicular or substantially perpendicular to the side by the driven conveyor and from a first vertical level relative to a loading edge of the storage device or airport wagon and further comprising discharging one or more following objects on or in said storage device or airport wagon from a second vertical level, which is increased relative to the first vertical level.

29. The method according to claim 28, wherein the first vertical level is equal to or substantially equal to, or just slightly above a vertical level of an upper edge of the storage device or airport wagon.

30. The method according to claim 28, wherein the second vertical level is about 0.05-0.40 meter above an upper edge of the storage device or airport wagon.

31. The method according to claim 1, wherein an end of the driven conveyor from which the objects are discharged is aligned with or substantially aligned with the side of said storage device or airport wagon and/or is adjoining or substantially adjoining the side of the storage device or airport wagon.

32. The method according to claim 1, further comprising:
manually spreading objects already present in the storage device or airport wagon one or more times prior to having a filled storage device or airport wagon and, while momentarily stopping, discharging objects into the storage device or airport wagon prior to manually spreading the objects.

33. The method according to claim 1, wherein one or more certain types of one or more objects, are selected for being discharged on or in the storage device or airport wagon, at a certain moment during filling of the storage device or airport wagon, or discharging a soft object or a soft baggage piece, as the initial object onto or into a yet unfilled storage device or airport wagon.

34. The method according to claim 1, further comprising selecting one or more objects for discharging at a given moment on or in a particular storage device or airport wagon among a plurality of storage devices or airport wagons.

35. The method according to claim 34, wherein discharging on or into a left side storage device (or airport wagon) or a right side storage device or airport wagon is provided by reversing the driving direction of the driven conveyor belt.

36. The method according to claim 34, wherein discharging on or into a particular storage device or airport wagon from the side of the storage devices or airport wagons, is provided by transferring the driven conveyor in a direction corresponding to a direction of the width side of one or more storage devices or airport wagons.

37. The method according to claim 1, wherein the storage device or airport wagon, when filled to a certain level, is moved from the second area to an aeroplane at which aeroplane the objects collected in the storage device or airport wagon is loaded into the aeroplane from the storage device or airport wagon.

38. The method according to claim 1, wherein the filling of a storage device or airport wagon is determined and upon reaching a certain predetermined level stopping the filling of the present storage device or airport wagon and, when necessary, starting the filling of a further storage device or airport wagon.

39. An object handling system, wherein the system is adapted to transport objects of varying size, shape and weight from a first area to a second area, comprising: a discharge means adapted to discharge the objects at least at two different levels of speed into at least one elongate intermediate storage device.

40. The object handling system according to claim 39, wherein the system comprises a control system adapted to direct the object to an intended discharge location and determining the speed level for the intended discharge location.

41. The object handling system according to claim 40, wherein the control system operates according to a predetermined scheme or algorithm and based on the intended destination and the present filling state of the relevant storage device, said control system determines the relevant discharge speed for the object and/or a vertical level of the discharge means.

42. The object handling system according to claim 39, wherein the discharge means comprises a driven conveyor or a pusher, and further comprises a control means adapted to control the discharge speed of the object by controlling the speed of the driven conveyor or the speed of the pusher.

43. The object handling system according to claim 39, wherein the system comprises a plurality of conveyor means adapted to transport objects from a first area to a second area, at which second area said objects are loaded on or in a storage device or an airport wagon, said system further comprising:
a driven conveyor adapted to discharge objects into said storage device or airport wagon or to collect a plurality of objects in the storage device or airport wagon, the driven conveyor being configured to discharge objects directly on or in said storage devices from a side of said storage device and substantially perpendicular to the side by the driven conveyor from a first vertical level relative to an upper edge of the storage device, and
a control system for controlling operation of the system, the control system furthermore being configured to discharge one or more initial objects on or in the storage device with a driving speed of the driven conveyor which is slower or faster than the driving speed of the driven conveyor upon discharging one or more following objects which follows the initially discharged objects.

44. The object handling system according to claim 39, wherein said object handling system is configured to discharge one or more of said following objects on or in said storage device or airport wagon from a second vertical level, which is increased relative to a first vertical level.

45. The object handling system according to claim 39, wherein a plurality of storage devices, or 2-8 storage devices are positioned in the second area and the driven conveyor is provided in a transfer system, which transfer system is configured to transfer the driven conveyor with one or more objects on the conveyor, to a position so as to discharge the one or more objects on or into one of said storage devices or airport wagons from a side of said storage device or airport wagon.

46. The object handling system according to claim 45, wherein the transfer system and control system are adapted to transfer a plurality of objects on one or more driven conveyors comprised in the transfer system at once so as to discharge selected objects being transferred on the one or more driven conveyors to one or more selected intermediate storage devices or airport wagons.

47. The object handling system according to claim 39, further comprising a detector, which detects the filling of a storage device or airport wagon, wherein the detector comprises a counter, a photoelectric sensor and/or a camera with relevant pattern recognition software.

48. The object handling system according to claim 43, wherein the control system comprises a memory that stores information on a certain destination for an intermediate storage device, a memory that stores information on the last discharged object and a discharge speed controller that determines the discharge speed for the next following object into the intermediate storage device.

49. The object handling according to claim 48, wherein the control system further comprises a memory that stores information on the present filling of an intermediate storage device and a control system that allocates a next storage device upon reaching a predetermined level of filling, when a predetermined number of objects are loaded, or when a predetermined height in the present storage device is reached.
